(19) United States
(12) Patent Application Publication
(10) Pub. No.: US 2009/0260955 A1
(43) Pub. Date: Oct. 22, 2009

(54) Workplace carrier and conveyor system

(75) Inventors: Matthias Krups, Koenigswinter (DE); Peter Krups, Anhausen (DE)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Ceratis GmbH

(21) Appl. No.: 12/386,706

(22) Filed: Apr. 22, 2009

Related U.S. Application Data
(60) Provisional application No. 61/126,866, filed on May 8, 2008.

(30) Foreign Application Priority Data
Apr. 22, 2008 (DE) 10 2008 020 052.2

(51) Int. Cl. B65G 17/12; B65G 47/64

(52) U.S. Cl. 198/793

(57) ABSTRACT

A workpiece carrier for transporting workpieces on a conveyor path comprises a carrier element for receiving a workpiece. The carrier element is connected with a plurality of support elements for absorbing weight. Further, the carrier element is connected with a guide element in order to guide the carrier element in a load-free manner or without absorption of weight. To form an active, self-propelled workpiece carrier, at least one drive assembly is provided. Drive assembly comprises a drive element resting on a conveyor path.

### CROSS-REFERRED APPLICATIONS

This application claims priority to U.S. Provisional Application No. 61/126,866, filed on May 8, 2008, which is incorporated herein in its entirety.

### BACKGROUND

1. Field of the Disclosure

The disclosure refers to a workpiece carrier and a conveyor system comprising such a workpiece carrier.

2. Discussion of the Background Art

Conveyor systems are used, especially in mass production, to transport workpieces between individual workplaces where the workpieces are assembled or treated, for example. To achieve this, the workpieces are placed on workpiece carrier and the workpiece carrier is moved together with the workpieces by corresponding conveyor means. For moving the workpiece carrier, friction conveyors are known, wherein the workpiece carrier are not rigidly secured to the conveyor means, but lie loosely on rolls, belts or plates, for example. The workpiece carriers are moved by friction. It is a particular advantage of friction conveyors that the workpiece carrier can back up at or between workstations. To this avail, the rolls provided to drive the workpiece carrier have friction clutches that slip during a back-up process. Friction conveyors require no intricate and complicated unlatching or the like from a conveyor means such as a chain. Further, friction conveyors allow for a simple realization of curves and branches.

A friction conveyor particularly suited for transporting heavy workpieces is known from DE 10 2006 045 573. The workpiece carrier provided in this friction conveyor system, comprise a carrier element as well as a motion element. The motion element, especially of plate-shaped structure, comprises a friction surface that rests on the friction conveyor, such as the rolls. Via a connecting element, such as a web part, a carrier element is connected with the motion element, the carrier element preferably being also plate-shaped and arranged in parallel with the motion element. The bottom face of the carrier element is provided with supporting elements such as rollers or wheels. The supporting elements lie on a bearing surface that defines a conveyor path. The weight force of the workpiece arranged on the carrier element is received via a absorption element connected, for example, with a carrier frame. Only a small portion of the weight of the workpiece, if any, is transferred to the motion element. With the friction conveyor described in DE 10 2006 045 575, what is essential, among other things, is the separation of the weight or load support and the motion element resting on the friction conveyor, such as the friction rolls. At the same time, the motion element acts as a guide for the workpiece carrier along the conveyor path. To achieve this, the lateral sides of the plate- or dish-shaped motion element are guided in corresponding grooves or rest on lateral guide walls.

Due to the separation of the workpiece carrier into a motion element and a carrier element, it is possible to give them different sizes. This allows for rather small motion elements that move a correspondingly large carrier element that receives workpieces and has large dimensions. It is thus possible to create a modular system wherein identical motion elements are connected with different carrier elements, especially carrier elements of different sizes or carrier elements having different fastening elements for the fixation of workpieces.

The friction conveyor described in DE 10 2006 045 575 is driven by means of rollers m for example, which abut a friction surface, especially a bottom face of the motion element. When the workpiece carrier is stopped at a treatment station or when the workpiece carriers back up, it is necessary to interrupt the transmission of force from the rollers to the motion elements. This is achieved by providing the driven rollers with friction clutches. The friction clutches have to be adjusted precisely depending on the back-up pressure. Further, regular readjustment and maintenance of the friction clutches are required. Moreover, friction clutches are expensive components.

Further, active or self-propelled workpiece carriers are known. These are not divided into a carrier element and a motion element. Rather, a usually plate-shaped carrier element is provided for receiving the workpieces, the bottom side thereof being provided with wheels. One or a plurality of said wheels is connected with an electric motor for driving. Further, each workpiece carrier has a rechargeable battery for operating the electric motor. Such workpiece carrier are heavy. Moreover, such workpiece carrier are disadvantageous, in particular when transporting heavy workpieces, in that the weight of the workpiece also acts on the driven roller, so that the drive shaft is loaded heavily and thus has to be of solid design.

It is an object of the disclosure to provide a workpiece carrier that allows for a simpler, especially more economic and more low-maintenance structure. Moreover, it is an object of the disclosure, to provide a corresponding conveyor system.

### SUMMARY OF THE DISCLOSURE

In the workpiece carrier of the present disclosure, first, the separation of a carrier element, connected with support elements for absorbing the weight of the workpiece, and a guide element is maintained. Here, the guide element substantially serves to merely guide the carrier element along the conveyor path, the weight of the workpiece substantially not being borne by the guide element. The present workpiece carrier for transporting workpieces on a conveyor path, especially a conveyor path formed by a conveyor system, therefore comprises a preferably plate-shaped carrier element for receiving a workpiece. Especially the bottom face of the carrier element is provided with a plurality of support elements, such as wheels or rollers, to receive the weight of the workpiece. Via the support elements, e.g. in the form of wheels, at least a major part of the weight of the workpiece placed on the carrier element is supported. In particular, the whole weight of the workpiece is transferred to the conveyor path or supported thereon via the support elements. The carrier element is connected with a guide element for guiding the carrier element along the conveyor path. Here, the guide element is configured such that the guiding can be performed free of load or without absorbing weight. In a preferred embodiment, the guide element thus exclusively serves as a guide for the workpiece carrier, where the weight of the workpiece does not have to be supported by the guide means. This will be effected solely via the support elements.

According to the present disclosure, a drive assembly is provided. The at least one drive assembly comprises a drive element, in particular a drive element resting on the conveyor path, for actively moving the workpiece carrier. The drive element, which preferably has two driven wheels, serves to actively move the workpiece carrier. To do so, the drive element especially abuts the conveyor path, but it may also rest on another element of the conveyor system, such as a drive path independent from the conveyor path. Here, the drive force may be transmitted by friction from the drive element to the drive path or conveyor path. Possibly, instead of transmitting the drive forces by friction, or in addition thereto, the drive force may be transmitted through form—fit connections such as toothed racks meshing with a drive element in the form of a pinion.

According to the disclosure, the workpiece carrier comprises a contact element for current supply, provided in particular at the guide element. Thus, a battery can be omitted. Providing the contact element at the guide element, as preferred according to the disclosure, is advantageous in that the contact element can be arranged at a position protected from soiling, e.g., at the bottom face of the conveyor path. Since it is further preferred that the drive assembly is connected with the at least one guide element, providing the contact element at the guide element has the further advantage of allowing for a simple energy supply to the drive assembly. In a particularly preferred embodiment, the contact element is arranged on an upper surface of the guide element directed towards the carrier element.

Due to the at least one drive element provided according to the disclosure, rollers or belts provided in a friction conveyor can be omitted. Correspondingly, it is no longer necessary to provide friction clutches to allow for slipping during backing up. Manufacturing and maintenance costs can thereby be reduced significantly. This is especially true since the drive assembly, in a preferred embodiment, comprise electric motors that are inexpensive and require little maintenance.

Since the conveyor paths may also comprise branches and curves, it is preferred that the at least one drive assembly is pivotably connected with the carrier element. Here, the at least one drive assembly is preferably connected with the carrier element such that they are freely pivotable and that moreover the weight of the workpiece is preferably not absorbed via the drive assembly. For example, the drive assembly may be held so as to be vertically slidable such that only horizontal forces, i.e. drive forces, can be transmitted from the drive assembly to the carrier element. Possibly, the drive assembly are elastically, in particular resiliently, connected with the carrier element, in particular below the carrier element. Here, a direct connection of the drive assembly with the bottom face of the carrier element is preferred, an indirect connection between the drive assembly and the carrier elements, e.g. via the guide element, also being possible. Thus, it is also possible to connect the drive assembly with the guide element connected with the carrier element.

In a particularly preferred embodiment, the drive assembly, preferably comprising two drive elements such as wheels or rollers, is fixedly connected with the guide element so that the drive assembly is pivoted together with the guide element, especially when the workpiece carrier is moved around a curve or along a branch. Because of the preferred provision of two drive elements, such as drive rollers, per drive assembly, a gap in the conveyor path can be passed smoothly especially when the workpiece carrier is moved in the area of a branch. In a preferred embodiment, the gap is provided to realize the especially web-shaped connection of the guide element provided below the conveyor path with the carrier element.

Preferably, the at least one drive assembly includes two drive elements. The two drive elements, such as wheels or rolls, are arranged on different sides of the guide element, seen in the transport direction. For a guide element of T-shaped cross section, for example, which is connected with the bottom face of the carrier element through a web part or a tab, the two drive assembly are located on the right and on the left, seen in the transport direction, beside the web part or a connection element. The connecting element of the guide element is preferably arranged extending through a slot in the guide path, said slot running in the longitudinal or transport direction. For branches, it is thus required that the drive elements move over the slot. This is readily possible when at least two drive elements are provided, since at least one drive assembly always remains in contact with the drive or guide path. The drive elements of the preferably several drive assembly may have a common drive, such as an electric motor. Sets of drive assembly having common drives may also be provided. It is preferred that at least two drive elements or at least two sets of drive elements have a separate drive. Thus, at curves or branches, travelling the different paths is made possible in a simple manner.

The two drive elements provided in the preferred embodiment are preferably connected with a common holder element. The common holder element surrounds the connecting element of the guide element at least partly. Here the holder element is especially shaped like a sleeve. Since the drive assembly, and thus the two drive elements, are preferably fixedly connected with the guide element, in particular with the guide shoe of the guide element, the holder element is preferably fixedly secured to the guide shoe. Hereby, it is achieved that the guide shoe turns together with the drive elements when following a curve or a branch. This is advantageous in that the position of the drive elements is always parallel to the guide slot in which the connection element is situated. Preferably, the drive assembly and the guide element thus have a common pivot axis.

The two drive elements preferably have a separate electric motor, in order to well negotiate the different radii especially when travelling curves. Preferably, hub motors are provided as the drive units.

To ensure that branches can be realized with the workpiece carrier of the present disclosure, at least four support elements, preferably in the form of rollers, are provided. Since the supporting elements have to travel over the guide slot at a branch, it is particularly preferred that each of the preferably four support elements comprises two rollers or a double roller. As an alternative, it is possible to provide more than four, especially six rollers, for example, with three rollers being respectively arranged in succession along the direction of transport. This guarantees that upon travelling over a slot always at least two of the three rollers contact the guide path. Thus, a tilting or wobbling of the workpiece carrier is avoided.

It is particularly preferred to configure the support elements as castor guide rollers. Thereby, travelling through curves is facilitated. The support elements, which in particular are wheel pairs, are thus pivotably connected especially with the bottom face of the carrier element receiving the workpiece.

The connection element is preferably provided on the bottom face of the carrier element and in particular extends vertically. Opposite the carrier element, a guide shoe of the guide element is provided, the guide shoe being connected with the carrier element through the connection element. In particular, the guide shoe is formed as a disk or plate and is preferably arranged in parallel with the carrier element, especially the bottom of the carrier element. Vertically opposite the guide shoe, the at least one drive element is provided. When moving the workpiece carrier on a bearing element forming a conveyor path, at least a part of the bearing element forming the conveyor path is arranged in the vertical direction between the guide shoe and the at least one drive assembly.

In a particularly preferred embodiment, the workpiece carrier is connected with a switch element for actuating the drive assembly. For example, when approaching a workstation or in a back-up situation, the switch element switches off the drives so that the workpiece carrier automatically stops at the workstation. The switch element may have an optical sensor, for example, configured as a distance sensor and stopping a workpiece carrier at a certain predefined distance, seen in the direction of travel, from another workpiece carrier, or reducing the speed, for example. Thus, a mechanical bumping into the foregoing workpiece carrier can be avoided or it may at least be ensured that a collision occurs only at low speed differences. The corresponding switch means may also be used to stop the workpiece carrier at workstations. However, this may also be effected through corresponding signals, especially radio signals.

In another embodiment, the switch element has a switching part which is mechanical, in particular. The switching part may be formed similar to a bumper, the switching part being connected slidably, especially in a horizontal direction, with the carrier element or another element of the workpiece carrier. When a workpiece carrier bumps into another workpiece carrier or by bumping into a stopper at a workstation, the switching part is actuated by vertical displacement. This causes an interruption of the current supply or a deactivation of the drives. The switching means may be spring loaded, so that the switching part is released again, for example when a back-up is dissolved or when a stopper is removed at a workstation, thereby automatically restoring the electrical contact. This simple mechanical structure of the switching element has the advantage of being extremely reliable.

Further, the disclosure refers to a conveyor system preferably comprising the above described workpiece carrier. The conveyor system includes a absorption element supported by a frame, for example, and being flat, in particular. In a preferred embodiment, an upper surface of the absorption element forms the conveyor path. Via the absorption element, which preferably is shaped in the manner of a bridge, the workpiece carrier itself and especially the weight of the workpiece carrier are received. The absorption element may have a slot, for example, extending in the longitudinal direction. The slot may be a guide slot, so that the workpiece carrier is guided via the connection element arranged in the guide slot. However, it is preferred that the guiding is effected via the guide shoe of the guide element and not the connection element. This is advantageous in that brushes, for example, may be provided in the slot to avoid dirt from entering the same. In this preferred embodiment, the guiding is preferably effected via the guide shoe, with guide walls being preferably provided at the bottom face of the carrier element, against which the guide shoe abuts. Here, lateral surfaces of the guide shoe may rest immediately on the guide walls. Preferably, the guide shoe comprises slide elements, such as slide rollers, which rest on the guide walls. According to the disclosure, the guide element is connected or in contact with the guide means such that only a very small portion, if any, of the weight of the workpiece is transferred, the guiding preferably being load-free and without absorption of forces.

Independent of the provision of guide walls or a guide slot, the present guide system comprises an electric contact rail. The electric contact rail is provided in the conveyor path, the contact rail especially being provided on the bottom face of the conveyor path. Thus, it is possible to configure a guide element, also provided below the guide path, with a contact element facing towards the bottom face of the conveyor path and thereby making electric contact with the contact rail. This arrangement of the contact rail, as well as the contact element is especially preferred since it prevents a soiling of the electric contacts.

In a particularly preferred embodiment, the contact rail is provided at the absorption element of the conveyor system, especially at the bottom face of the absorption element. The contact element, which in this embodiment is preferably connected with the conveyor element of the workpiece carrier, engages into the contact rail preferably from below. This reduces the risk of soiling the contact rail.

Preferably, the guide element has a T- or L-shaped cross section and is particularly connected with the bottom face of the carrier element. In a preferred embodiment, at least one leg of the guide element engages behind a part of the absorption element on the top surface of which the conveyor path is preferably formed. This not only realizes the guiding of the workpiece carrier, but also avoids tilting. The preferred embodiment is the guide element with a T-shaped cross section, so that tilting in both directions perpendicular to the transport direction is prevented. Here, the guide element preferably abuts against a bottom face of the absorption element.

The following is a detailed description of the disclosure with reference to a preferred embodiment and to the accompanying drawings.

### BRIEF DESCRIPTION OF THE DRAWINGS

FIG. 1 is a schematic top plan view on a preferred embodiment of a workpiece carrier,

FIG. 2 is a schematic side elevational view of the workpiece carrier, seen in the direction of an arrow II in FIG. 1, and

FIG. 3 is a schematic top plan view on a conveyor system according to the present disclosure.

### DETAILED DESCRIPTION OF THE PREFERRED EMBODIMENT

In the embodiment shown, the workpiece carrier comprises two guide elements 10 connected with a carrier element 12. Here, the guide element are of a T-shaped cross section so that a connection element 22 (FIG. 2) or a corresponding web part for connection with the carrier element 12 is formed. The guide element 10 further comprises a guide shoe 23 connected with the connection element 22. The guide shoe 23 is of plate-shaped design and is arranged substantially in parallel with the carrier element 12. The guide shoe 23 is connected with a bottom face of the carrier element 12 via the connection element 22.

At its upper surface 13 (FIG. 2), the carrier element 12 serves to receive workpieces, the weight force of the workpieces acting in the direction of the arrow 36.

In the embodiment illustrated, the bottom face 26 of the carrier element 12 is provided with eight support elements 28, each having a freely rotatable roller 30. In the embodiment shown, the weight of the workpiece is transferred completely from the support elements 28 onto the absorption elements 50 (FIG. 2) of a conveyor formed by a frame 44.

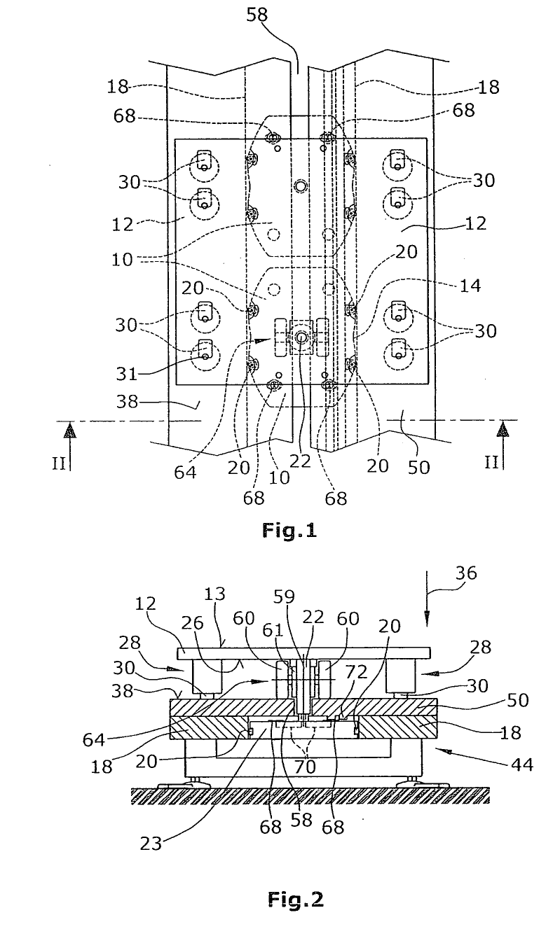

The individual rollers 30 are rotatable around axes 31 situated perpendicularly to the carrier element 12, as indicated by circles in FIG. 1. Since the axis 31 does not extend through the rotational axis of the rollers 30, the rollers 30 are castor rollers, so that the rollers 30 are orientated in the travelling direction of the workpiece carrier even when negotiating curves.

In the absorption element 50, on whose upper surface the rollers 30 run, a slot 58 is provided that extends in the transporting direction 16. The connection element 22 of the guide element 10 extends through the slot 58. The guide element 10 is connected with the carrier element 12 so as to be pivotable about the longitudinal axis 59 thereof. The connection element 22 is connected with the guide shoe 23 in a manner secured against pivoting about the longitudinal axis 59. To ensure that the weight force of the workpiece is not or only for a minor part transmitted to the guide shoe 23, the connection between the connection element 22 and the guide shoe 23 is elastic or resilient, preferably in the vertical direction.

About the connection element 22 a holder element 61 is arranged, which in the embodiment illustrated is sleeve-shaped. The two drive elements of the drive assembly 64, configured as rollers 60, are provided together with the holder element 61. Preferably, the holder element 61 is firmly connected with the guide shoe via the connection element 22. Pivoting the guide shoe 22 around the longitudinal axis 59 of the connection element 22 thus simultaneously causes the drive assembly 64 to pivot along.

In the embodiment illustrated, the workpiece carrier is guided by slide elements in the form of rollers 20 provided at the guide shoe 23. The rollers 20 are arranged laterally at the guide shoe 23 and slide on inner sides of guide walls 18 connected with a bottom face of the carrier element 12.

Since, according to the disclosure, the workpiece carrier is an active, i.e. self-propelled, workpiece carrier, the disclosure provides for drives, such as electric motors, at the bottom face 26 of the carrier element 12. In the embodiment shown, the electric motors each drive a drive wheel 60 via drive shafts 62. Here, as illustrated in FIG. 1, both electric motors 64 are pivotable to allow a good and simple movement of the workpiece carrier along curves.

In order to guarantee that the workpiece carrier is guided as accurately as possible, the guide element 10 has lateral bulges 14 by which the workpiece carrier can be guided in curves or at branches. In a simple embodiment, however, it is also sufficient that the guide element is in the form of a circular disc or plate.

In the embodiment illustrated, electric lines 70 are indicated for the energy supply of the electric motors, which lines start from the electric motors and extend through the connection element 22 into the guide element 10. The guide element 10 is connected with two contact elements 68. One of the contact elements 68, which, in particular, is resilient, rests against a contact rail 72. The contact rail 72 is arranged in the longitudinal or transport direction. Because of the arrangement of the contact rail 72 on a bottom face of the absorption element 50, a soiling of the contact rail is avoided.

In the preferred embodiment illustrated, each workpiece carrier has two guide elements 10 arranged in succession in the direction of transport. As described above with reference to FIG. 2, at least one of the guide elements 10 is provided with a drive assembly which is pivotable about the axis 59, preferably together with the guide shoe 23. The second guide element may additionally have a further drive assembly. To be able to guide the workpiece carriers also along curves and branches, such as illustrated e.g. in FIG. 2, the disclosure preferably only provides straight contact rails 72. As a consequence, the contact rails are interrupted in the area of a curve or branch, since, according to the disclosure, no bent contact rails are provided. If only one drive assembly 64 is provided, both guide elements 10 preferably have a contact element 68, so that always at least one of the contact elements 68 is in electric contact with one of the straight contact rails 72. Via corresponding lines, the current is fed to the drive assembly 64.

When two drive assemblies 64 are provided, i.e. one drive assembly per guide element 10, it is sufficient to supply energy to one of both drive assembly in bent portions or branches.

In another preferred embodiment, the guide shoe 23 has two contact elements 68 at its upper side. This is advantageous in that, regardless of the arrangement of the workpiece carrier in the guide path, a connection with a contact rail 72 is always guaranteed. Further, for example at branches, it is of no importance, whether the contact rail 72 is on the same side of the workpiece carrier, seen in the direction of transport, when it is behind the branch, as it was on before the branch. In particular, this facilitates the restructuring of the present conveyor system.

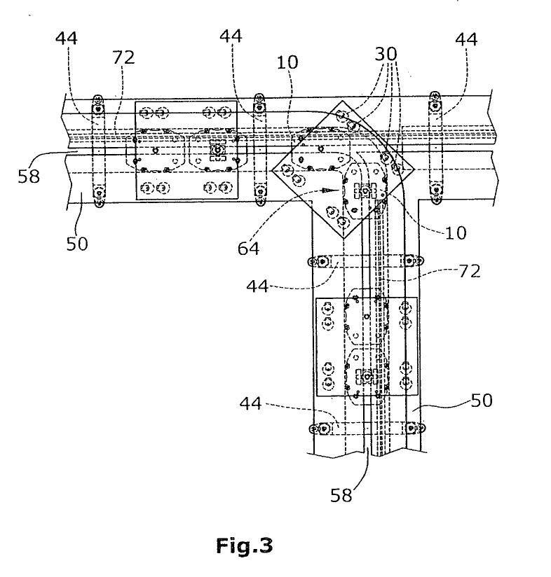

As is evident in particular from the schematic top plan view of FIG. 3, it is advantageous in the region of a bend that the guide elements 10 are pivotable about the axis 59 with respect to the carrier elements 12. Thus, it is guaranteed that the guide elements 10, through the contact elements 68, always assume the required orientation with respect to the contact rails 72.

Because of the bridge-like conveyor system, the tracks of the support elements 28 can be in another plane than the especially two guide elements 10. The tracks of the support elements 28 and the guide elements 10 or the contact elements 68 may thus intersect.

Especially due to the tandem arrangement of two respective support elements 28 or rollers 30, it is guaranteed that the track slot 58 can be travelled over without the workpiece carrier and the workpiece thereon tilting or wobbling. Here, the distance between the two support elements 28 is larger in the travelling direction than the slot region to be travelled over. Preferably, the distance between the support elements is larger than twice the slot width. Since the position of the individual support elements 28 with respect to the carrier element 12 remains substantially unchanged even when travelling through curves and is not pivoted together with the guide elements, the resistance against tilting of the workpiece carrier is clearly improved. This is of great importance especially in tight curves and when transporting workpieces not placed centrally or when no centric load is given.

In the embodiment illustrated, a mechanical switch element 74 of bumper-like structure is provided. The switch element 74 is connected with the carrier element for horizontal displacement through guide elements 76. When the workpiece carrier bumps into another workpiece carrier (back-up situation) or into a stopper at a workstation, the switch element 74 is displaced towards the carrier element. This causes the electric contact to open so that the energy supply to the drives 64 is interrupted.

What is claimed is:

1. A workpiece carrier for transporting workpieces on a conveyor path, comprising
a carrier element for receiving workpieces,
a plurality of support elements for absorbing weight, said elements being connected with the carrier element,
at least one guide element for guiding said carrier element without absorption of load, said guide element being connected with said carrier element,
a drive assembly independent of said support elements and comprising at least one drive element resting on the drive path for an active movement of the workpiece carrier, and
a contact element for supplying energy to the drive assembly, said contact element being connected with the guide element.

2. The workpiece carrier of claim 1, wherein said contact element is arranged on an upper surface of said guide element facing towards the carrier element.

3. The workpiece carrier of claim 1, wherein said drive assembly is connected with the bottom face of said carrier element in an elastic or resilient manner.

4. The workpiece carrier of claim 1, wherein said guide element comprises a connection element for connection with said carrier element.

5. The workpiece carrier of claim 1, wherein said guide element comprises a guide shoe connected with the carrier element.

6. The workpiece carrier of claim 1, wherein said drive assembly comprises two drive elements arranged on different sides of the guide element.

7. The workpiece carrier of claim 6, wherein the two drive elements are carried by a common holder element, said holder element surrounding said connection element at least in part.

8. The workpiece carrier of claim 5, wherein the drive assembly is arranged opposite the guide element.

9. The workpiece carrier of claim 1, wherein each drive element of the drive assembly respectively comprises a separate drive.

10. The workpiece carrier of claim 1, wherein said drive assembly is pivotable relative to the carrier element.

11. The workpiece carrier of claim 1, further comprising a switch element for actuating the drive assembly.

12. The workpiece carrier of claim 11, wherein said switch element comprises a switch part connected with the carrier element and adapted to be displaceable, said switch part actuating the switch element by being displaced.

13. A conveyor system comprising:
an absorption element forming a conveyor path,
a workpiece carrier for transporting workpieces on said conveyor path, comprising:
a carrier element for receiving workpieces,
a plurality of support elements for absorbing weight, said elements being connected with the carrier element,
at least one guide element for guiding said carrier element without absorption of load, said guide element being connected with said carrier element, and
a drive assembly comprising at least one drive element resting on the drive path for an active movement of the workpiece carrier,
an electric contact rail provided in said conveyor path, said rail being connected with a contact element for the electric power supply to the drive assembly, said contact element being connected with said guide element.

14. The conveyor system of claim 13, wherein said guide element comprises a web-shaped connection element protruding through a slot in said absorption element and connected with said carrier element.

15. The conveyor system of claim 13, wherein said guide element comprises a guide shoe that rests on the bottom face of said absorption element and/or is arranged vertically below said absorption element.

16. The conveyor system of claim 13, wherein said absorption element is arranged at least in part between the guide shoe and the drive assembly.

17. The conveyor system of claim 13, wherein said contact rail is straight.

18. The conveyor system of claim 13, further comprising a guide path comprising curves and/or branches, wherein only straight contact rails are provided.

19. The conveyor system of claim 13, further comprising guide walls arranged on a bottom face of said carrier elements, at which walls slide elements are provided on the guide element for guiding the workpiece carrier.
